(19) United States
(12) Patent Application Publication
(10) Pub. No.: US 2025/0353114 A1
(43) Pub. Date: Nov. 20, 2025

(54) METHOD FOR COATING METAL WORKPIECES

(71) Applicant: TRUMPF Laser- und Systemtechnik SE, Ditzingen (DE)

(72) Inventors: Andreas SCHOLZ, Taunusstein (DE); Björn SAUTTER, Leonberg (DE); Patrick HAUG, Unteriflingen (DE); Nicolai SPEKER, Pleidelsheim (DE)

(21) Appl. No.: 19/280,211

(22) Filed: Jul. 25, 2025

Related U.S. Application Data
(63) Continuation of application No. PCT/EP2024/051302, filed on Jan. 19, 2024.

(30) Foreign Application Priority Data
Jan. 27, 2023 (DE) 10 2023 102 043.9
Jan. 27, 2023 (DE) 10 2023 102 044.7

(51) Int. Cl. B23K 26/342; B23K 26/06; B23K 26/067; B23K 26/073

(52) U.S. Cl. CPC B23K 26/342; B23K 26/0604; B23K 26/0648; B23K 26/067; B23K 26/0732

(57) ABSTRACT

A method for coating a metal workpiece by laser deposition welding includes moving the workpiece to be coated, and irradiating a surface of the workpiece by at least one laser beam to generate at least a first irradiation zone and a second irradiation zone on the surface of the workpiece. The second irradiation zone precedes or follows the first irradiation zone along a machining direction. The method further includes introducing a powdery additional material into the first irradiation zone. The additional material at least partially enters the at least one laser beam before impinging on the surface of the workpiece and thereby is at least partially heated.

### CROSS REFERENCE TO RELATED APPLICATIONS

This application is a continuation of International Application No. PCT/EP2024/051302 (WO 2024/156621 A2), filed on Jan. 19, 2024, and claims benefit to German Patent Application No. DE 10 2023 102 044.7, filed on Jan. 27, 2023 and to German Patent Application No. DE 10 2023 102 043.9, filed on Jan. 27, 2023. The aforementioned applications are hereby incorporated by reference herein.

### FIELD

Embodiments of the present invention relate to laser deposition welding. In particular, embodiments of the invention relate to a method and a device for coating metal workpieces, in particular brake discs, by using high-speed laser deposition welding.

### BACKGROUND

Methods for high-speed laser deposition welding are known from the prior art and are described, for example, in DE 10 2011 100 456 B4. This method achieves a significant increase in the achievable machining speed compared to conventional laser deposition welding by supplying at least one additional material in at least partially molten form to a process zone present on a surface to be machined. For this purpose, the additional material, which is initially powdery, is heated by means of a laser beam at a distance from the workpiece surface and fed into the process zone, which is also heated by the laser beam. The feed movement—i.e., the relative movement between the surface to be coated and the machining beam—is largely realized in high-speed laser deposition welding by a movement, in particular a rotation of the workpiece to be coated. By means of high-speed laser deposition welding, the machining speed of the laser deposition welding process can be significantly increased.

In high-speed laser deposition welding, also referred to as high-speed laser metal deposition (HS-LMD), a significant portion of the laser power is absorbed by the powder flow of the additional material and by metal vapor generated during the machining process. However, to achieve a sufficient bond between the workpiece and the coating layer, it is important that the workpiece surface has a required minimum temperature. To pre-heat the workpiece, it is therefore known to heat the workpiece over a large area using induction.

However, this large-scale heating is comparatively complex and requires a comparatively large amount of energy. In addition, the pre-heating temperature cannot be adjusted precisely. Furthermore, for example, when pre-heating a brake disc made of gray cast iron by means of induction, the pre-heating temperature is limited because the surface of the brake body oxidizes above a temperature of approximately 300° C. An oxidized surface would negatively affect the coating process and the quality of the coating.

### SUMMARY

Embodiments of the present invention provide a method for coating a metal workpiece by laser deposition welding. The method includes moving the workpiece to be coated, and irradiating a surface of the workpiece by at least one laser beam to generate at least a first irradiation zone and a second irradiation zone on the surface of the workpiece. The second irradiation zone precedes or follows the first irradiation zone along a machining direction. The method further includes introducing a powdery additional material into the first irradiation zone. The additional material at least partially enters the at least one laser beam before impinging on the surface of the workpiece and thereby is at least partially heated.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic of the creation of two irradiation zones during high-speed laser deposition welding according to some embodiments;

FIG. 2 shows schematically process components in the high-speed laser deposition welding according to some embodiments;

FIGS. 3a-3d show a schematic representation of different configurations for pre-heating and/or post-heating during high-speed laser deposition welding according to some embodiments;

FIG. 4 shows a schematic representation of the different residence times of powder particles during high-speed laser deposition welding in the process zone on a workpiece surface to be coated according to some embodiments;

FIG. 5 schematically shows an optical arrangement of a device according to some embodiments for high-speed laser deposition welding;

FIG. 6 shows a diagram illustrating delamination in the wear protection layer of a workpiece coated by high-speed laser deposition welding according to some embodiments; and

FIGS. 7a-7n show a schematic representation of further different configurations for pre- and/or post-heating during high-speed laser deposition welding according to some embodiments.

### DETAILED DESCRIPTION

Embodiments of the present invention can improve the coating of metal workpieces by means of laser deposition welding. In particular, bonding errors between the coating layer and the coated workpiece, or between adjacent layers of the coating layer (what is termed delamination), can be avoided, even at high machining speeds.

According to a first aspect, a method for coating a metal workpiece by means of laser deposition welding is provided. The method comprises, in a first step, moving, in particular rotating, the workpiece to be coated. The workpiece can preferably be a brake disc for a motor vehicle. The workpiece can have a base body which can consist essentially of cast iron, in particular of gray cast iron. An intermediate layer made of a material, preferably also a metallic material, in particular a stainless steel, can be applied to the base body on the surface of the workpiece to be coated. The intermediate layer serves, for example, to improve the bonding of the wear protection layer to be applied to the workpiece. Furthermore, the intermediate layer can serve to stop cracks in the wear protection layer to be applied. The composition of the intermediate layer can be selected depending on the material of the wear protection layer to be applied.

In a second step, the method comprises irradiating a surface of the workpiece by means of at least one first laser beam to generate at least one first irradiation zone and a second irradiation zone on the workpiece surface, wherein the second irradiation zone precedes or follows the first irradiation zone along a machining direction. The first irradiation zone can also be called the process zone. The second irradiation zone can also be referred to as a pre-heating zone or a post-heating zone, depending on the location thereof in the upstream or downstream section of the process zone. The machining direction is essentially determined by the movement of the workpiece. When coating a brake disc, for example, in addition to the rotation of the workpiece, the machining beam is moved in a radial direction, resulting in a spiral-shaped machining path. In this case, the machining direction can be a tangent of the machining path starting from the center of the first irradiation zone. In addition to spiraling machining paths, helical machining paths or simple straight, circular or other machining paths can also be realized. It is not always necessary to move the machining beam in addition to moving the workpiece. The workpiece surface is heated locally by at least the first laser beam in the process zone as well as in the pre-heating zone or the post-heating zone.

In a third step of the process, an additional material, preferably a powdery additional material, is introduced into the first irradiation zone (i.e., into the process zone). The additional material can preferably be introduced into the process zone in the form of one or more powder jets by means of a preferably inert carrier gas. Alternatively, it would also be conceivable to add a wire-shaped additional material. The additional material is fed into the process in such a way that it at least partially enters the first laser beam, preferably over the entire cross-section thereof, before it impinges on the workpiece surface, at a predetermined distance from the workpiece surface and is thereby at least partially heated, preferably over the entire cross-section thereof. In this case, the additional material or at least part of the additional material is at least partially melted so that when it impinges on the workpiece surface in the also heated process zone it can quickly bond with the material of the workpiece and produce a material bond with particularly low mixing of the joining partners. The focus of a powder jet supplied from several directions can be in the area of the surface (e.g., in the surface plane) of the workpiece to be coated, preferably above the workpiece surface. Depending on the application, the focus of a powder-fed additional material can also be below the workpiece surface, i.e., in the workpiece or below the workpiece. The additional material preferably consists of a material that has a higher wear resistance than the base body of the component. In particular, the additional material can comprise an iron-containing matrix material which in particular forms a matrix of stainless steel in which hard material particles, such as tungsten carbide particles or titanium carbide particles, are embedded. In the coating process, the additional material preferably forms a flat wear protection layer on the workpiece surface. Wear protection can be increased by the carbide deposits in the coating layer. When coating a brake disc, the number of braking cycles and thus the service life of the brake disc can be increased (particularly by reducing abrasion during braking).

The method according to embodiments of the invention makes it possible to pre-heat the workpiece surface precisely and efficiently along the machining path immediately before the additional material impinges on the process zone or after passing through the process zone to improve the bonding of the additional material to the workpiece surface and to avoid bonding errors. The formation of other defects—e.g., pores—in the material structure of the coating layer can also be counteracted. Compared to the large-area pre-heating according to the prior art, the energy input into the workpiece is much more targeted. Furthermore, the temperature can be very quickly adapted to changing thermal conditions during a coating process. In this way, the quality of the coating can also be increased. Compared to large-area heating of the workpiece to be coated, the influence on the metallurgical properties of the workpiece can be reduced by using less energy. In the method according to embodiments of the invention, preferably no pronounced melt pool is produced on the surface of the workpiece to be coated. A penetration depth (or impact depth) into the workpiece to be coated by the at least first laser beam can preferably be at most 20 μm, preferably at most 10 μm, even more preferably at most 5 μm. In this case, pre-heating of the workpiece surface can contribute in particular to the cleaning and/or outgassing of carbon from the workpiece to be coated, an improved wettability of the workpiece surface with the additional material and/or an improved bond between the additional material and the workpiece.

In the method according to embodiments of the invention, it can additionally be provided that an inert protective gas, for example argon, helium, or inert gas mixtures, is directed together with the at least first laser beam through the machining nozzle of a machining head onto the first illumination zone to shield the welding process from the reaction with oxygen from the ambient air and to prevent corrosion of the coating path or the heated workpiece surface.

In the coating method according to embodiments of the invention, a resulting feed rate, i.e., a speed of the relative movement between the workpiece surface and the machining beam, can preferably be at least 20 m/min.

In the method according to embodiments of the invention, it can also be provided that the workpiece to be coated is not subjected to any additional pre-heating, in particular no large-area pre-heating by induction, in addition to the pre-heating by the at least first laser beam. By eliminating the pre-heating time and the inductive pre-heating device, the process time and process costs can be reduced.

According to a variant, a third irradiation zone can also be generated by means of the at least first laser beam. The third irradiation zone is arranged so that it is opposite the second machining zone starting from the first irradiation zone. For the sake of simplicity, it is assumed below that the second irradiation zone is the preceding pre-heating zone and the third irradiation zone is the following post-heating zone.

In the method according to embodiments of the invention, at least two laser beams can be used. Accordingly, the first irradiation zone can be generated by means of the first laser beam and the second irradiation zone can be generated by means of a second laser beam. The third irradiation zone can additionally be generated by a third laser beam. The first laser beam and the second laser beam, as well as (optionally) also the third laser beam, can also each be designed as partial beams (i.e., first partial beam, second partial beam and (optionally) third partial beam) of a common laser output beam. Preferably, the second laser beam and/or the third laser beam has a different intensity in the irradiation plane (i.e., plane of the workpiece surface or surface plane of the applied layer) than the first laser beam. In particular, the intensity of the second laser beam in the plane of the workpiece surface can be lower than the intensity of the first laser beam.

The second laser beam and/or the third laser beam can also be supplied to the process from a separate beam source, for example, laterally. In this way, the laser power of the individual laser beams can be easily adjusted independently of each other. This also makes it easy to position the pre-heating beam and/or the post-heating beam on the machining path. Furthermore, laser beams with different wavelengths than those used for the actual coating process can be used for pre-heating and/or post-heating. The wavelengths can be precisely adjusted to a material-specific coupling and the efficiency of the pre-heating and/or post-heating can thus be increased. Furthermore, the pre-heating beam and/or the post-heating beam could be radiated from outside the feed of the additional material onto the workpiece surface or the weld bead and would in particular not be influenced by a powder jet of the additional material arranged concentrically around the first laser beam.

As an alternative to using several separate laser beams or partial laser beams, only one laser beam can be used, which preferably has an asymmetric beam profile that is elongated in the machining direction (e.g., oval or rectangular), wherein a front partial area of the projection of the laser beam on the workpiece surface forms the second irradiation zone and a subsequent partial area of the projection forms the first irradiation zone. The extension of the asymmetric laser beam can additionally cover the third irradiation zone, which follows the first irradiation zone and reheats the produced weld bead or the applied additional material to additionally prevent bonding errors or delamination between individual application layers.

When using several separate laser beams or partial laser beams, the first laser beam and/or the second laser beam and/or the third laser beam has a plateau-shaped intensity distribution. The described intensity distribution is particularly present in the beam focus of the respective laser beam. Alternatively, at least one of the laser beams can have a Gaussian intensity distribution. A plateau-shaped intensity distribution, also known as a top-hat distribution, has the advantage over a Gaussian intensity distribution that it enables a more uniform heating of both the workpiece surface and the additional material across the entire beam cross-section of the laser beam, particularly in the edge areas thereof.

Alternatively or additionally, the first laser beam and/or the second laser beam and/or the third laser beam have an intensity distribution with an intensity maximum in the edge region of the respective laser beam. In particular, the first and/or the second and/or the third laser beam can each have a circular cross-section with an annular intensity distribution over the beam cross-section. The intensity is therefore lower in the center of the beam than in the peripheral area thereof. A laser beam with an annular intensity profile enables an even more uniform heating of the workpiece surface and/or the, in particular powdery, additional material during laser deposition welding.

The fluence applied in the second irradiation zone is preferably in the range of 0.01 J/mm² up to 5 J/mm². In the specified fluence range, the influence of heating by the laser radiation on the metallurgy of the workpiece to be coated can be kept to a minimum due to a low penetration depth. In particular, the penetration depth of the pre-heating can be in the range of 5 μm to 500 μm starting from the workpiece surface. Preferably, the irradiation in the second irradiation zone can be adjusted such that a pre-heating temperature of the workpiece in the second irradiation zone is in a range of 5% of the melting temperature up to the evaporation temperature of the workpiece to be coated.

A laser power of the second laser beam and/or a laser power of the third laser beam can be changed during a coating process. For example, the laser power of the second laser beam and/or the third laser beam can be changed by changing the resulting feed rate. The laser power of the second and/or third laser beam at the beginning of a coating process can also have a first value which is reduced according to a specification to compensate for process-related heating of the component during the coating process and to create the most similar possible thermal conditions throughout the entire coating process. Analogous to the adjustment of the laser power of the second and/or third laser beam, the laser power of the first laser beam can also be changed if necessary. By changing the laser power, especially of the second laser beam, the pre-heating of the workpiece surface can be precisely and flexibly adapted to the external conditions.

The sum of the laser powers of all laser beams used for the coating process can be at least 1 kW, preferably at least 8 kW. The proportion of the laser power for the second laser beam in the total power can be in the range of 0.05% to 75%, in particular in the range of 1% to 50%.

At least one of the laser beams used can have a wavelength in the range of 0.4 μm to 2 μm. A beam quality of at least one of the laser beams can be in the range of 2 mm*mrad to 500 mm*mrad. A 2-in-1 or an n-in-1 optical fiber or a single-core fiber can be used to guide at least the first laser beam or a laser output beam underlying the first (partial) laser beam. An n-in-1 optical fiber within the meaning of the present disclosure has at least one central light-guiding core region and at least one light-guiding ring region surrounding the core region for transporting the laser beam, wherein the light-guiding regions are preferably spaced apart from one another by a cladding. When using an n-in-1 optical fiber, the power portion of the laser beam guided in the central fiber core can be at least 15% of the total power. For the coating process, a device with a welding head can preferably be used, which comprises welding optics, by means of which the first laser beam is focused onto the process zone together with a powder gas jet containing the additional material and furthermore at least a beam portion of the first laser beam or a second laser beam is focused onto the pre-heating zone. The focus diameter of at least one of the laser beams is in the range of 1 mm to 20 mm. The laser beam(s) can be focused onto the workpiece surface to be coated so that the focus diameter thereof lies in the surface plane of the workpiece, or is offset by a few mm upwards or downwards from the surface plane. To split a laser output beam into at least the first and second (partial) laser beams, a corresponding optical element (for example an optical wedge or a diffractive optical element) can be arranged in the beam path of the collimated laser output beam.

A distance of the second irradiation zone (pre-heating zone) from the first irradiation zone (process zone) and/or a distance of the third irradiation zone (post-heating zone) from the first irradiation zone in the machining direction can be at least 0.5 times the focus diameter of the first laser beam and at most 5 times the focus diameter of the first laser beam. The first laser beam and the second laser beam and/or the third laser beam can in particular have an identical, in particular circular, outer diameter. In the case of an annular intensity profile of the laser beams, which can be generated, for example, when using a 2-in-1 or n-in-1 optical fiber by using the laser portion guided in an annular fiber core of the n-in-1 fiber, an overlap of the irradiation zones can be preferred. The distance between the irradiation zones is determined by the distance between the centers of the irradiation zones in a common plane (in case of doubt in the surface plane of the workpiece to be coated). Preferably, the irradiation zones can be spaced apart from one another in such a way that they are just adjacent to one another without significantly overlapping or without having a significant gap between them.

The additional material can be supplied to the first irradiation zone in such a way that an irradiation window remains for generating the second irradiation zone and/or for generating the third irradiation zone. In other words, the powder feed can be designed in such a way that the second laser beam or a corresponding portion of the first laser beam for generating the pre-heating zone (second irradiation zone) is not obscured by the powder flow. The same applies to the third laser beam or a corresponding portion of the first laser beam for generating the post-heating zone (third irradiation zone). For example, the additional material can be fed exclusively laterally with respect to the machining direction and/or piercingly, i.e., from a direction following the process. It is understood that if the additional material is fed in a piercing manner, any post-heating zone would be at least partially covered. However, a concentric feed of the additional material is also conceivable. A variant can be particularly preferred in which the additional material is fed to the first irradiation zone from several positions distributed around the first laser beam (or via individual nozzles distributed in a ring shape or via a C-shaped slot nozzle), wherein no powder feed takes place from the leading direction, so that the second laser beam or a corresponding portion of the first laser beam can be directed onto the workpiece surface unhindered through the existing recess in the powder feed. To generate a post-heating zone, an analogous recess can be provided in the powder feed.

In principle, it is preferred if the additional material is blown into the process zone in powder form by means of a carrier gas, in particular an inert one. The powder mass flow in the process according to embodiments of the invention can preferably at least 20 g/min. To avoid oxidation processes during coating, additional gassing can be provided. In particular, an inert gas, for example argon, can be blown through a machining nozzle through which the laser beam(s) also emerge onto at least the machining zone.

The second irradiation zone and/or the third irradiation zone can be arranged to be orthogonally offset from the machining direction relative to the first irradiation zone. This allows the curvature of the machining path to be taken into account for pre-heating and/or post-heating, particularly in the case of circular, spiraling, or helical material application. The influence of the pre-heating and/or post-heating on a part of the process zone or the immediate surroundings thereof can be adjusted via lateral displacement of the pre-heating area and/or the post-heating area. This can be necessary when welding with track overlap, for example if only the workpiece or only the intermediate layers are to be pre-heated.

The second laser beam and/or the third laser beam can each have a rectangular beam cross-section. The rectangular beam profile can be aligned orthogonally to the machining direction. This results in a uniform fluence distribution in the pre-heating zone and the post-heating zone.

The second irradiation zone (pre-heating zone) and/or the third irradiation zone (post-heating zone) can each have a different size than the first irradiation zone (process zone). For example, for the area A2 of the second irradiation zone, this can give: 0.1*A1≤A2<A1 (with A1=area of the first irradiation zone). With a smaller pre-heating spot, the influence of the pre-heating on a part of the process zone can be adjusted. This can be advantageous when welding with track overlap, for example if only the workpiece surface or only the intermediate layers of the coating are to be pre-heated. Conversely, the following can also apply to the area A2 of the second irradiation zone: A1<A2≤3*A1. When using a larger pre-heating zone compared to the process zone, previously applied coating sections (in particular the turns of a coating applied in a spiraling manner) can be subjected to heat treatment at the same time as the powder is applied. Furthermore, with a comparatively large pre-heating zone, the effort required for precise positioning of the second laser beam relative to the first laser beam is reduced.

Depending on the application, however, a configuration in which the irradiation zones are of equal size can also be desirable. In particular, in some cases this can optimize the efficiency of energy input.

In particular, the size of the projection area of the laser beam(s) on the workpiece surface, and thus the size of the irradiation zones, can be variably adjusted.

According to another aspect, a device for laser deposition welding is provided. The device comprises a carrier unit for a metal workpiece to be coated, wherein the carrier unit has a movement unit for moving, in particular for rotating, the workpiece. The device further comprises a laser beam unit for providing at least one first laser beam and for generating, by means of at least the first laser beam, at least one first irradiation zone and a second irradiation zone on a surface of the workpiece to be coated, wherein the second irradiation zone precedes the first irradiation zone along a machining direction. The device also comprises a feed unit for feeding an additional material, in particular a powdery additional material, into the first irradiation zone, wherein the additional material can be fed to the first irradiation zone in such a way that it at least partially enters the first laser beam before it impinges on the workpiece surface in the first machining zone and is thus at least partially heated.

The laser beam unit preferably has optics having a collimation unit and a focusing unit, as well as having a beam splitter element. The beam splitter element is arranged between the collimation unit and the focusing unit in the beam path of the optics and is designed to split a laser output beam into the first laser beam and at least one second laser beam.

The beam splitter element can be, for example, an optical wedge, a cylindrical lens or a diffractive optical element (DOE). Facet optics or a microlens array can also be used as a beam splitter element. By means of the optical wedge and the DOE, as well as facet optics or a microlens array, separate partial beams can be generated, by means of which the workpiece surface is exposed to the respective irradiation zone. Using the cylindrical lens, an elliptical beam profile of the laser beam can be generated so that the laser beam irradiates the respective irradiation zones on the workpiece surface with a continuous beam spot.

The device can further comprise a displacement unit by means of which the optical element designed as an optical wedge or as a DOE can be displaced laterally in the beam path of the laser output beam to distribute the laser power to the resulting laser beams.

According to a third aspect, a workpiece is provided which can be produced by means of a coating method according to embodiments of the invention. The workpiece is in particular a brake disc. The workpiece comprises a metallic base body, in particular a disc-shaped base body. The base body can in particular be made of cast iron, for example gray cast iron. The workpiece further comprises at least one coating layer which is arranged, preferably in a spiraling manner and with overlapping coating paths, on a surface of the base body and is integrally connected to the base body. The workpiece has a mixing region at a transition between the base body and the coating layer, which has a thickness of at most 20 μm, preferably of at most 10 μm, more preferably of at most 5 μm. The material bond between the base body and the coating layer is formed in the mixing region.

According to a preferred variant, the workpiece can have several coating layers, each having a different material composition. For example, a first coating layer can be formed as an intermediate layer made of stainless steel, which is applied to the surface of the base body. A second coating layer applied to the intermediate layer can be composed of a matrix material in which hard material particles, for example tungsten carbide or titanium carbide, are embedded in a matrix of stainless steel. Between each of the coating layers and/or between overlapping turns of a coating layer as such, a mixing region with a respective maximum thickness of 20 μm, preferably of at most 10 μm, more preferably of at most 5 μm, can be formed between the adjacent layers/turns. The workpiece is particularly characterized by a strong, defect-free connection between the base body and the coating layer, as well as between adjacent coating layers (or winding paths), in which the material structure of the different materials and the properties thereof in the area of the connection are only minimally influenced.

The workpiece can preferably be produced by means of a method according to embodiments of the invention according to one of the variants described above.

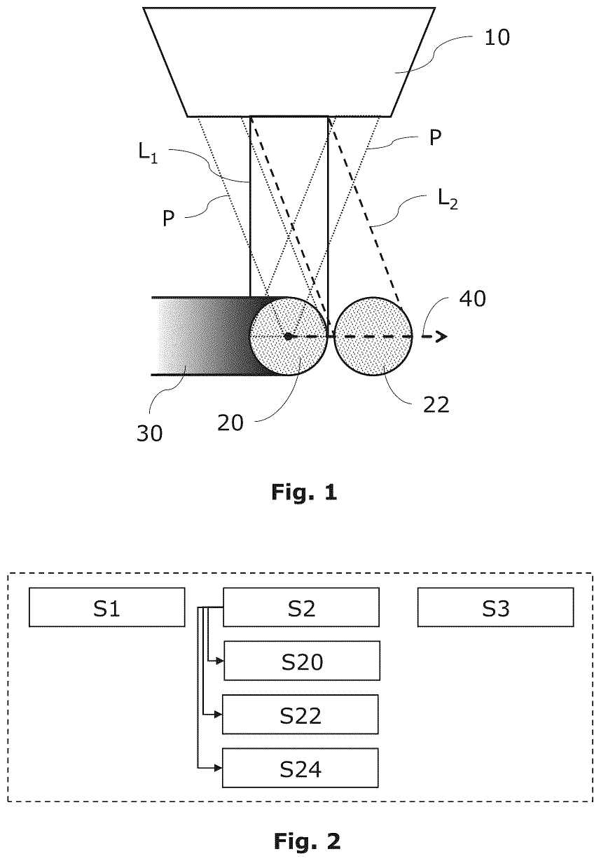

FIG. 1 schematically shows a nozzle 10 from which exit a first laser beam L₁ and a second laser beam L₂. When the first laser beam L₁ is irradiating a workpiece surface (not shown), a first irradiation zone 20 is generated on the workpiece surface and the second laser beam L₂ generates a second irradiation zone 22 in an analogous manner. By moving the workpiece to be coated and/or the nozzle 10 relative to each other, the laser beams L₁, L₂ move in a machining direction 40 along a predetermined machining path over the workpiece surface. A powdery additional material P is also irradiated into the first laser beam L₁ via the nozzle 10 so that the powder particles irradiated by the first laser beam L₁ are heated and impinge on the workpiece surface along the machining path in the first irradiation zone 20 (process zone). Due to the simultaneous heating of the powder particles and the workpiece surface in process zone 20, a solid bond is formed very quickly when the powder particles impinge on the workpiece surface. As a rule, no complete common melt pool is formed. The partially molten material deposit in the process zone 20 subsequently solidifies into a weld bead 30. To accelerate the coating process and at the same time minimize the occurrence of bonding errors, the workpiece surface is pre-heated by the second laser beam L2 in the second irradiation zone 22 (pre-heating zone) in the run-up to the process zone 20. To further improve the bonding of the material deposit (additional material P) to the workpiece or the bonding of overlapping material deposit paths (defect pattern of what is termed delamination), following from the process zone 20 the weld bead 30 can also be heated in a third irradiation zone (24, see FIGS. 2b and 2d) by means of laser radiation.

FIG. 2 shows schematically process steps of a coating process according to embodiments of the invention. Step S1 represents the moving, in particular the rotating, of a workpiece to be coated. In step S2, a surface of the workpiece is irradiated by means of at least the first laser beam L₁ to generate S20 at least the first irradiation zone 20 and to generate S22 the second irradiation zone 22 on the workpiece surface, wherein the second irradiation zone 22 precedes the first irradiation zone 20 along a machining direction 40. Furthermore, in an optional sub-step S24, the third irradiation zone 24 can also be generated by means of the at least first laser beam L₁. In a step S3, the additional material P is introduced into the first irradiation zone 20, wherein the additional material P at least partially enters the first laser beam L₁ before it impinges on the workpiece surface, and is thereby at least partially heated.

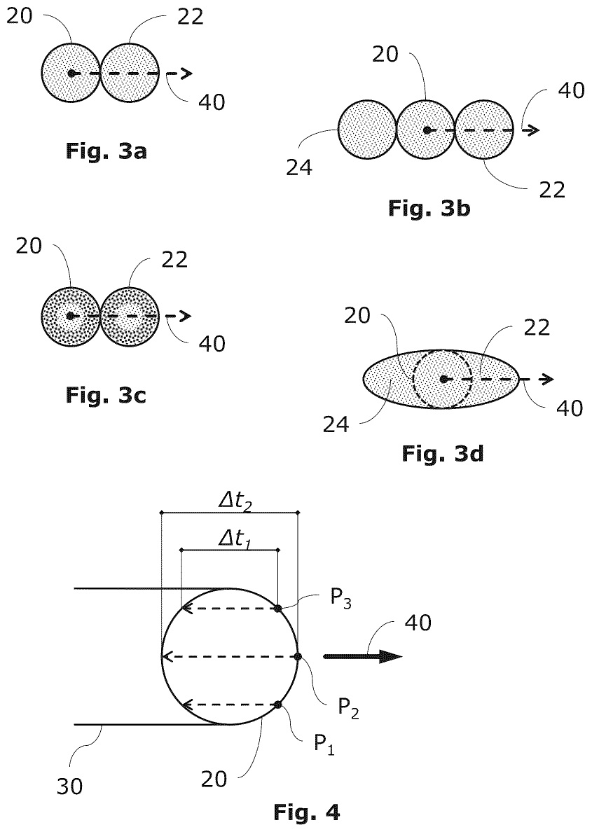

FIGS. 3a through 3d schematically show various configurations for pre-heating and/or post-heating within the framework of a coating process according to embodiments of the invention. FIG. 3a shows a configuration in which the workpiece surface to be coated is irradiated by two laser beams, wherein a projection of the first laser beam L₁ on the workpiece surface forms the first irradiation zone 20 and a projection of the second laser beam L₂ forms the second irradiation zone 22 on the workpiece surface. The second irradiation zone 22 precedes the first irradiation zone 20 in the coating process along the machining direction 40. FIG. 3b shows a configuration in which, in addition to the irradiation zones 20, 22 according to FIG. 3a, a third irradiation zone 24 is generated by means of a third laser beam L₃, wherein the third irradiation zone 24 follows the first irradiation zone 20 along the machining direction 40 to heat the additional material P applied in the process zone 40 in a controlled manner. FIG. 3d also shows a configuration in which three irradiation zones 20, 22, 24 are generated on the workpiece surface or on the weld bead 40. In contrast to the representation according to FIG. 3b, however, the irradiation zones 20, 22, 24 are generated here by means of a contiguous beam spot (or a projection) of a single laser beam. For this purpose, the laser beam used preferably has an asymmetric beam profile in cross-section, in particular an oval beam profile, as shown in FIG. 3d.

FIG. 3c shows the irradiation configuration in a particularly preferred embodiment of a coating method according to embodiments of the invention. The irradiation configuration differs from the irradiation configuration according to FIG. 3a in that the laser beams L₁ and L₂ generate irradiation zones 20, 22 with an annular intensity distribution. In other words, more energy per area is introduced into the edge region of the respective irradiation zone 20, 22 than into the respective core region. As a result, a more uniform energy distribution across the width of the respective irradiation zone 20, 22 along the machining direction 40 takes place compared to irradiation with a top hat-shaped or a Gaussian-shaped intensity distribution and thus a more uniform heating of the irradiated surface or the powder particles of the additional material P. The illustration in FIG. 4 further illustrates the advantage of a beam profile with an annular intensity distribution. Here, the process zone 20 is shown and three powder particles P₁, P₂, P₃ distributed across the width of the process zone 20, and each arranged at the preceding end of the process zone 20. It can be inferred from the representation that due to the circular process zone 20, the powder particle P₂, which impinges centrally, travels a longer distance in the process zone 20 during the movement of the process zone 20 along the machining direction 40, and is consequently heated for a longer period Δt₂ than the powder particles P₁ and P₃ that impinge on the edge of the process zone, which have a comparatively short residence time Δt₁ in process zone 20 and are therefore heated less strongly. For an annular intensity distribution of the first laser beam L₁, this uneven energy input across the width of the machining track can be counteracted.

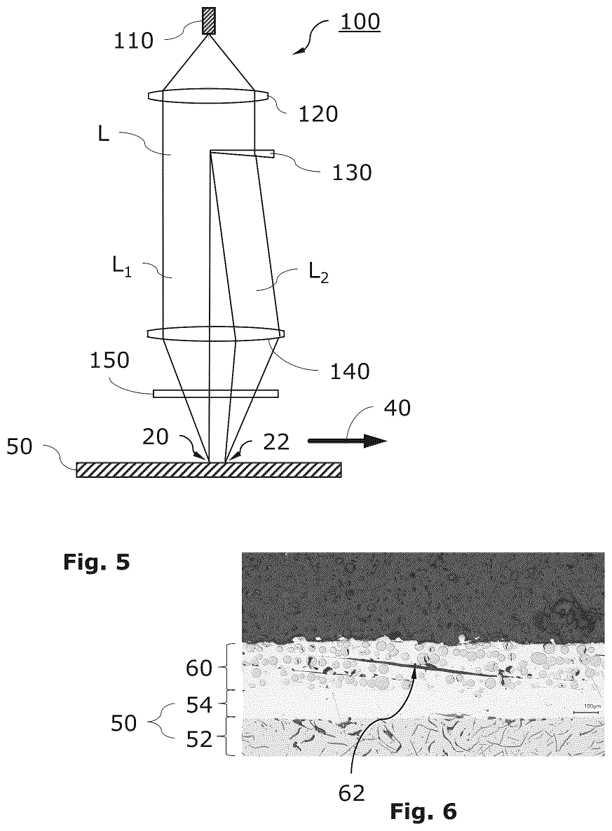

FIG. 5 schematically shows the structure of optics 100 which can be used for a device for the coating method according to embodiments of the invention. The optics 100 can in particular be arranged in a machining head of the device. A laser output beam L is collimated onto a collimation unit 120, in particular a collimation lens, via a fiber optic cable 110—for example with a 2-in-1 fiber. In the beam path of the collimated laser output beam L, a beam splitter element 130—here in the form of an optical wedge—is arranged which is displaceable transversely to the propagation direction of the laser output beam L and by means of which the laser output beam L is divisible into a first (partial) laser beam L₁ and a second (partial) laser beam L₂. By lateral positioning of the beam splitter element 130 in the laser output beam L, the total power of the laser output beam L can be directed specifically to the laser beams L₁ and L₂ be divided. The laser beams L₁ and L₂ are then focused onto the surface of a workpiece 50 to be coated via a focusing unit 150—here a focusing lens—and in doing so each generate a corresponding irradiation zone 20, 22 on the workpiece surface.

FIG. 5 shows a cross-section of the coating of a workpiece coated by laser deposition welding. The workpiece 50 comprises a base body 52 and an intermediate layer 54 applied to the base body 52. A coating layer 60 is applied to the intermediate layer 54. The coating layer 60 comprises a plurality of overlapping coating tracks, or overlapping turns of a contiguous coating track. The coating layer 60 as shown in FIG. 6 shows bonding defects 62 between two adjacent coating layers. This defect is also referred to as delamination. The coating method proposed here is intended to counteract the formation of delaminations 62 and bonding defects between the coating layer 60 and the workpiece 50.

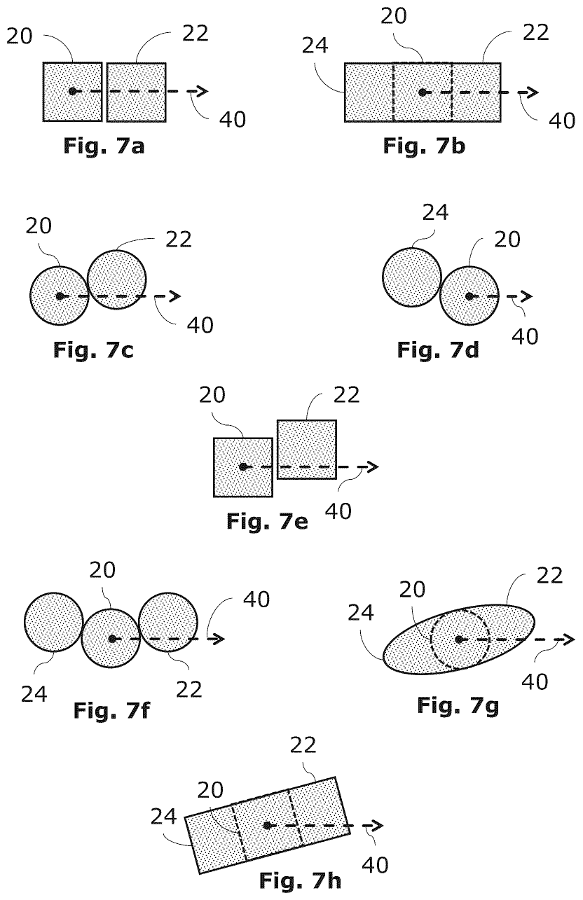

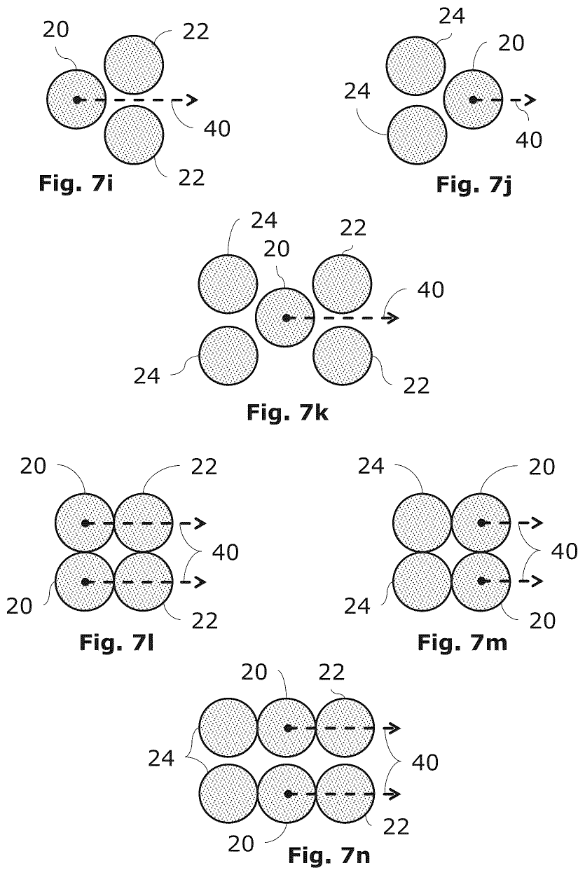

In FIGS. 7a through 7n, analogous to FIGS. 3a through 3d, further exemplary configurations for pre-heating and/or post-heating within the framework of a coating process according to embodiments of the invention are shown schematically. In connection with the description of FIGS. 3a through 3d, the representations in FIGS. 7a through 7n are self-explanatory for the person skilled in the art, which is why a detailed description of the individual arrangements of the laser beam projections with the different beam cross-sections is omitted at this point. However, it should be mentioned that by arranging one or more laser beams laterally offset or at an angle on the workpiece surface (see FIGS. 7c through 7k) the spiraling course of the coating path can be taken into account during pre-heating and/or post-heating of the workpiece and/or at least one previous turn of the coating layer.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for coating a metal workpiece by laser deposition welding, the method comprising:
moving the workpiece to be coated;
irradiating a surface of the workpiece by at least one laser beam to generate at least a first irradiation zone and a second irradiation zone on the surface of the workpiece, wherein the second irradiation zone precedes or follows the first irradiation zone along a machining direction; and
introducing a powdery additional material into the first irradiation zone, wherein the additional material at least partially enters the at least one laser beam before impinging on the surface of the workpiece and thereby is at least partially heated.

2. The method according to claim 1, further comprising:
generating, by using the at least one laser beam, a third irradiation zone which is formed on the surface of the workpiece to be coated in a direction opposite to the second irradiation zone with respect to the first irradiation zone.

3. The method according to claim 1,
wherein the first irradiation zone is generated by a first laser beam of the at least one laser beam, the second irradiation zone is generated by a second laser beam of the at least one laser beam; and
wherein the second laser beam has a different intensity in a plane of the second irradiation zone than the first laser beam in a plane of the first irradiation zone.

4. The method according to claim 3,
wherein the first laser beam and/or the second laser beam has a plateau-shaped intensity distribution.

5. The method according to claim 3,
wherein the first laser beam and/or the second laser beam has an intensity distribution with an intensity maximum in an edge region of the first laser beam or the second laser beam.

6. The method according to claim 3,
wherein a laser power of the second laser beam is changed during a coating process.

7. The method according to claim 1,
wherein a distance of the second irradiation zone from the first irradiation zone in the machining direction corresponds to at least 0.5 times a focus diameter of the at least one laser beam and at most 5 times the focus diameter of the at least one laser beam.

8. The method according to claim 1,
wherein the additional material is supplied to the first irradiation zone in such a way that an irradiation window for generating the second irradiation zone remains.

9. The method according to claim 1,
wherein the second irradiation zone is offset orthogonally to the machining direction relative to the first irradiation zone.

10. The method according to claim 3,
wherein the second laser beam has a rectangular beam cross-section.

11. The method according to claim 1,
wherein the second irradiation zone has a different size than the first irradiation zone.

12. A device for laser deposition welding, the device comprising:
a carrier for a metal workpiece to be coated, wherein the carrier has a movement unit for moving the workpiece;
a laser source for providing at least one laser beam and for generating, by the at least one laser beam, at least a first irradiation zone and a second irradiation zone on a surface of the workpiece to be coated, wherein the second irradiation zone precedes the first irradiation zone along a machining direction; and
a feeder for feeding an additional material into the first irradiation zone in such a way that the additional material at least partially enters the at least one laser beam in the first irradiation zone before impinging on the surface of the workpiece and thereby is at least partially heated.

13. The device according to claim 12,
wherein the laser source comprises optics having a collimation unit, a focusing unit, and a beam splitter arranged between the collimation unit and the focusing unit in a beam path of the optics, wherein the beam splitter is configured to divide a laser output beam into a first laser beam and at least one second laser beam of the at least one laser beam.

14. The device according to claim 13,
wherein the beam splitter comprises an optical wedge, or a cylindrical lens, or a diffractive optical element (DOE).

15. A workpiece comprising:
a metallic base body;
at least one coating layer on a surface of the base body and is integrally connected to the base body;
wherein the workpiece has a mixing region at a transition between the base body and the at least one coating layer, the mixing region having a thickness of at most 20 μm.
